(19) United States
(12) Patent Application Publication
(10) Pub. No.: US 2022/0067457 A1
(43) Pub. Date: Mar. 3, 2022

(54) LEARNING PRIVACY-PRESERVING OPTICS VIA ADVERSARIAL TRAINING

(71) Applicant: NEC Laboratories America, Inc., Princeton, NJ (US)

(72) Inventors: Francesco Pittaluga, Los Angeles, CA (US); Giovanni Milione, Monmouth Junction, NJ (US); Xiang Yu, Mountain View, CA (US); Manmohan Chandraker, Santa Clara, CA (US); Yi-Hsuan Tsai, Santa Clara, CA (US); Zaid Tasneem, Houston, TX (US)

(21) Appl. No.: 17/412,704

(22) Filed: Aug. 26, 2021

Related U.S. Application Data
(60) Provisional application No. 63/074,010, filed on Sep. 3, 2020.
(60) Provisional application No. 63/114,125, filed on Nov. 16, 2020.

(51) Int. Cl. G06K 9/62; G06N 3/04; G06F 21/60

(52) U.S. Cl. CPC G06K 9/6284; G06F 21/60; G06N 3/0454; G06K 9/6263

(57) ABSTRACT

A method for acquiring privacy-enhancing encodings in an optical domain before image capture is presented. The method includes feeding a differentiable sensing model with a plurality of images to obtain encoded images, the differentiable sensing model including parameters for sensor optics, integrating the differentiable sensing model into an adversarial learning framework where parameters of attack networks, parameters of utility networks, and the parameters of the sensor optics are concurrently updated, and, once adversarial training is complete, validating efficacy of a learned sensor design by fixing the parameters of the sensor optics and training the attack networks and the utility networks to learn to estimate private and public attributes, respectively, from a set of the encoded images.

### RELATED APPLICATION INFORMATION

This application claims priority to Provisional Application No. 63/074,010, filed on Sep. 3, 2020, and 63/114,125, filed on Nov. 16, 2020, the contents of both of which are incorporated herein by reference in their entirety.

### BACKGROUND

### Technical Field

The present invention relates to computer vision technologies and, more particularly, to methods and systems for learning privacy-preserving optics via adversarial training.

### Description of the Related Art

The ongoing transformation of computer vision research is driven by two interesting trends. First, the mobile revolution has made available billions of small, networked cameras, which have brought computer vision to the Internet of Things (IoT). In addition, the advent of deep learning has enabled inference on large datasets, improving existing vision techniques and creating novel applications. These advances have the potential to positively impact a wide range of fields including security, healthcare, search and rescue, and more. However, the privacy implications of releasing millions of networked vision sensors into the world would likely lead to significant societal push-back and legal restrictions.

### SUMMARY

A method for acquiring privacy-enhancing encodings in an optical domain before image capture is presented. The method includes feeding a differentiable sensing model with a plurality of images to obtain encoded images, the differentiable sensing model including parameters for sensor optics, integrating the differentiable sensing model into an adversarial learning framework where parameters of attack networks, parameters of utility networks, and the parameters of the sensor optics are concurrently updated, and, once adversarial training is complete, validating efficacy of a learned sensor design by fixing the parameters of the sensor optics and training the attack networks and the utility networks to learn to estimate private and public attributes, respectively, from a set of the encoded images.

A non-transitory computer-readable storage medium comprising a computer-readable program for acquiring privacy-enhancing encodings in an optical domain before image capture is presented. The computer-readable program when executed on a computer causes the computer to perform the steps of feeding a differentiable sensing model with a plurality of images to obtain encoded images, the differentiable sensing model including parameters for sensor optics, integrating the differentiable sensing model into an adversarial learning framework where parameters of attack networks, parameters of utility networks, and the parameters of the sensor optics are concurrently updated, and, once adversarial training is complete, validating efficacy of a learned sensor design by fixing the parameters of the sensor optics and training the attack networks and the utility networks to learn to estimate private and public attributes, respectively, from a set of the encoded images.

A system for acquiring privacy-enhancing encodings in an optical domain before image capture is presented. The system includes a differentiable sensing model fed with a plurality of images to obtain encoded images, the differentiable sensing model including parameters for sensor optics and an adversarial learning framework integrated with the differentiable sensing model where parameters of attack networks, parameters of utility networks, and the parameters of the sensor optics are concurrently updated. Once adversarial training is complete, validating efficacy of a learned sensor design by fixing the parameters of the sensor optics and training the attack networks and the utility networks to learn to estimate private and public attributes, respectively, from a set of the encoded images.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of an exemplary privacy-processing system including a training algorithm and a pre-capture privacy system, in accordance with embodiments of the present invention;

FIG. 2 is a block/flow diagram of an exemplary adversarial learning framework, in accordance with embodiments of the present invention;

FIG. 3 is a block/flow diagram of an exemplary sensor layer, in accordance with embodiments of the present invention;

FIG. 4 is a block/flow diagram of exemplary equations for aperture amplitude modulation, phase mask (phase modulation), and lens (phase modulation), in accordance with embodiments of the present invention;

FIG. 5 is a block/flow diagram of exemplary equations for pupil function, depth dependent point-spread-function, and image formation, in accordance with embodiments of the present invention;

FIG. 6 is a block/flow diagram of exemplary practical applications for the privacy-processing system, in accordance with embodiments of the present invention.

FIG. 7 is a block/flow diagram of exemplary Internet-of-Things (IoT) sensors used to collect data/information for the privacy-processing system, in accordance with embodiments of the present invention.

FIG. 8 is an exemplary practical application for the privacy-processing system, in accordance with embodiments of the present invention;

FIG. 9 is an exemplary processing system for executing the privacy-processing system, in accordance with embodiments of the present invention;

FIG. 10 is a block/flow diagram of an exemplary method for executing the privacy-processing system, in accordance with embodiments of the present invention;

FIG. 11 is a block/flow diagram of an exemplary sensor fabrication pipeline, in accordance with embodiments of the present invention; and

FIG. 12 is a prototype sensor with optimized phase mask, in accordance with embodiments of the present invention.

### DETAILED DESCRIPTION OF PREFERRED EMBODIMENTS

Successfully achieving computer vision at a mass scale still faces several challenges. First, privacy processing must occur prior to image capture, via optical filtering, to attenuate the increased risk of data sniffing attacks stemming from connectivity to Internet of Things (IoT). Second, while privacy and security have a long history of study in computer science, these have had limited impact for visual privacy. This is because the underlying nature of visual data (images, video, etc.) is fundamentally different from the data in most cybersecurity techniques. For example, in differential privacy, the data is assumed to be discretely labeled (e.g., n-tuples in a relational database). Similarly, in secure function evaluation, the explicit form of the function is known, whereas in most computer vision applications, the form of the functions is not explicit.

Conventional privacy solutions apply visual privacy algorithms after image capture. Such systems have an inherit vulnerability in that there exists a period, after capture, prior to privacy processing, where the raw data is vulnerable to attacks. This has resulted in the development of pre-capture privacy cameras that leverage specialized hand-crafted optics that filter sensitive attributes directly from the incident light-field prior to image capture and yet retain other useful information about the environment. While such hand-crafted optics are effective in certain domains, the design process lacks an explicit characterization of the aspects of an image that are informative towards a given inference task. Thus, the optically filtered data may still be vulnerable to novel attacks that leverage statistical estimators, such as deep neural networks, to extract hidden cues for private attributes. Further, the design process lacks generality as it cannot be easily adapted to design optics for other sensitive attributes features and/or utility tasks.

The exemplary embodiments introduce end-to-end optimization of the sensor optics and neural networks within an adversarial training framework to design pre-capture privacy sensors that maximize the utility and privacy of the captured data. Since privacy-processing occurs prior to image capture via optical filtering, the exemplary sensor eliminates the possibility of data sniffing attacks. Furthermore, since the exemplary approach is data-driven, it can be applied for any privacy attributes and/or utility tasks for which data is available.

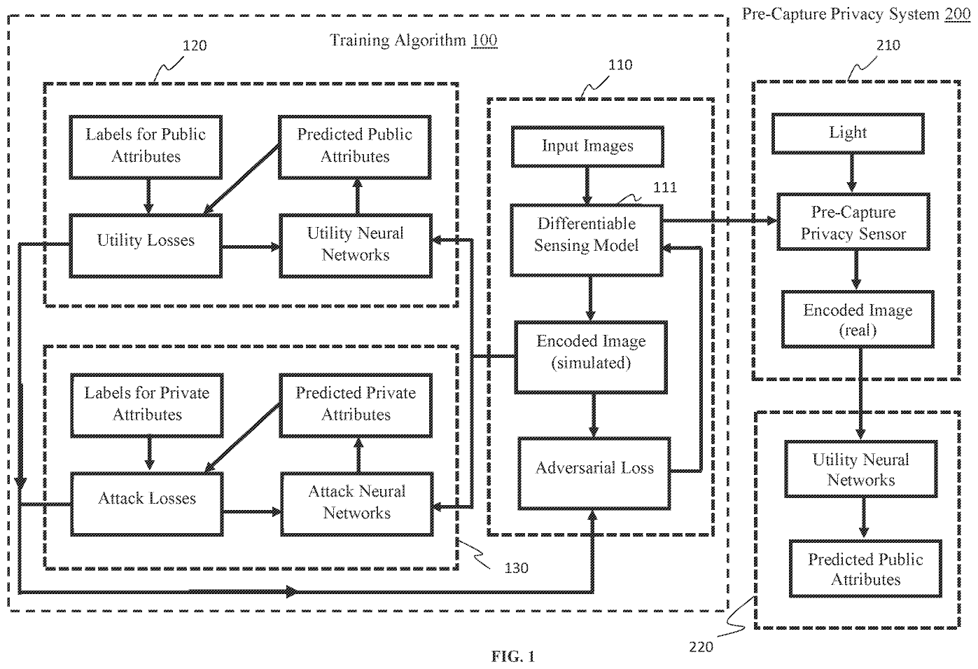

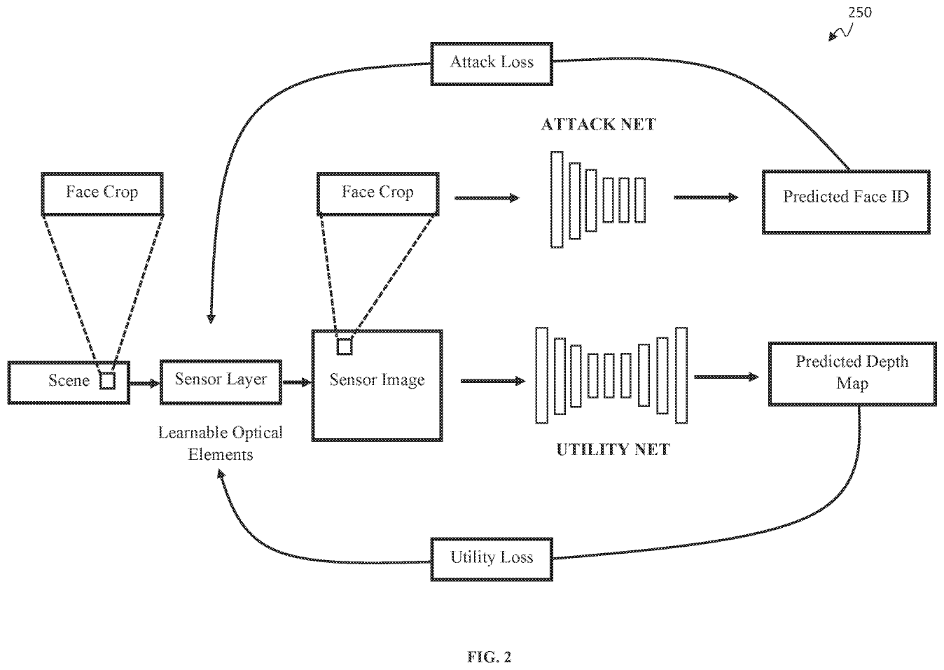

Regarding FIG. 1, and in reference to the training algorithm 100, the exemplary embodiments develop a differentiable sensing model that includes learnable parameters for the sensor optics. Second, the exemplary embodiments integrate the sensing model into an adversarial learning framework 250 (FIG. 2) in which the parameters of the sensor optics, the attack networks and the utility networks are all updated simultaneously or concurrently. The adversarial learning framework 250 enables end-to-end optimization of a sensor's optical elements with respect to both visual privacy and utility objectives. Third, once adversarial training is complete, the exemplary embodiments validate the efficacy of the learned sensor design by fixing parameters of the sensor optics and training various attack and utility networks to learn to estimate private and public attributes, respectively, from a set of encoded images. The exemplary approach is deemed a success if-and-only-if the utility networks succeed, and the attack networks fail. The outputs of the training algorithm 100 are the learned parameters for the sensor optics.

Regarding the sensor training module 110, input images are fed into the differentiable sensing model 111 to obtain a simulated encoded image. The sensing model 111 includes learnable parameters for the sensor optics which are optimized via an adversarial loss function to simultaneously or concurrently prevent the attack neural networks from succeeding at learning to estimate the private attributes from the encoded images and to enable the utility neural networks to succeed at estimating the public attributes from the encoded images.

Regarding the differentiable sensor model 111, the differentiable sensing model 111 includes parameterized optical components which can be optimized via standard learning algorithms such as stochastic gradient descent (SGD). The model 111 is designed to simulate how a sensor with the specified parameters would behave, that is, the model 111 takes as input a set of images of a given scene and outputs an encoded image that simulates what an image captured by the parameterized sensor would look like.

Regarding the training module 120 for utility networks, the parameters of the utility neural networks are optimized to map encoded images to public attribute labels.

Regarding the training module for attack networks 130, the parameters of the attack neural networks are optimized to map encoded images to private attribute labels to simulate an attack by an adversary seeking to recover the values of private attributes.

Regarding the pre-capture privacy system 200, the pre-capture privacy system 200 for computer vision includes two modules, that is, a pre-capture privacy sensor and a set of utility neural networks. A pre-capture privacy camera optically filters the incident light field to directly capture encoded images, which inhibit estimation of private attributes, but not of public attributes. The utility networks learned in the training step can be used to estimate the public attributes from the encoded images.

Regarding the pre-capture privacy sensor 210, once the training step is complete, the learned optical parameters are used to fabricate real optics components. The fabricated optics are then assembled into an optical train and fitted to an imaging system to create the pre-capture privacy sensor. The pre-capture privacy sensor 210 optically filters out facial features to inhibit face recognition and data sniffing attacks and optically encodes depth cues to enable monocular depth estimation.

Regarding utility neural networks 220, once the training step is complete and the parameters of the utility neural networks are fixed, the networks are then used as inference modules to estimate the values of public attributes in the encoded images captured by the pre-capture privacy sensor.

As noted above, computer vision is increasingly enabling automatic extraction of task-specific insights from images, but its use in ubiquitously deployed cameras poses significant privacy concerns. Standard images are inherently rich in visual information. Even if visual privacy methods are applied to sanitize captured images, they stay vulnerable to data sniffing attacks. This leads to two fundamental questions: Can computational cameras for machine intelligence be designed to excel at particular tasks while ensuring pre-capture privacy with respect to specific sensitive information? and, Can such cameras be realized in practice, to achieve advantageous privacy-utility trade-offs despite nonidealities in the modeling and fabrication process? The exemplary embodiments of the present invention answer both questions in the affirmative.

Conventional works on visual privacy have sought to generate image encodings that cannot be used to estimate sensitive attributes, while preserving some of the functionality of the original images. The most successful recent examples have used adversarial learning to balance competing privacy and utility objectives. In another line of “deep optics” works, joint design of sensor optics and computer vision algorithms achieve improved performance at a target task, such as high dynamic range imaging or monocular depth estimation. The exemplary embodiments build upon these works to achieve the novel capability of pre-capture visual privacy, with at least two advantages. First, in the exemplary embodiments, the encoding process occurs prior to image capture, so sensitive data is never recorded, which eliminates vulnerability to data leakage or sniffing. Second, in the exemplary embodiments, end-to-end optimization may even allow utility accuracy to meet or surpass standard images, while obfuscating private information.

The first contribution is an end-to-end adversarial learning framework for optimizing the sensor optics and vision algorithms with respect to both utility and privacy tasks. The designer must specify the utility function (whose information needs to be retained in the image) and the privacy function (whose information needs to be pre-filtered out before capture), following which the exemplary framework learns optics for an optimal privacy-utility trade-off. Besides unsusceptibility to data sniffing, the adversarial optimization of the camera design against a discriminator network seeking to recover sensitive data from censored images ensures that the design cannot be overcome by training on censored data.

The second contribution is to realize such a design in practice. For demonstration, the design space for all-optical encodings that the exemplary embodiments explore is quite modest, that is, control over an arbitrary phase mask pattern inserted in the aperture plane and the focus setting of the lens. This simple design space provides sufficient freedom to achieve highly interesting privacy-utility trade-offs. The exemplary embodiments conduct an extensive design space analysis to determine advantageous operating points that are also amenable to sensor fabrication and real-world constraints. In a significant deviation from standard modeling of the physics of the lens system, the exemplary embodiments also account for non-idealities such as zero-order diffractions, which is important to prevent privacy leakage from undiffracted light. Such physical considerations are part of the end-to-end adversarial learning of the phase masks, which the exemplary embodiments then fabricate and utilize in a hardware prototype for imaging in real-world environments.

The exemplary embodiments demonstrate through the learned and fabricated hardware prototype that high-quality depth maps can be achieved in real-world environments while successfully rendering human faces unidentifiable (FIG. 1).

In summary, the exemplary embodiments introduce a framework for jointly learning sensor optics and vision algorithms to achieve flexible privacy-utility tradeoffs. The exemplary embodiments further introduce end-to-end learning of a phase mask inserted in the aperture plane of a camera, with physically based modeling important to privacy. The exemplary embodiments further introduce systematic analysis of elements of the sensor design space and the resulting privacy-utility trade-off and physical realization of a hardware prototype by fabricating the learned phase mask to achieve good trade-offs in real-world scenes.

The goal is end-to-end optimization of a sensor's optical elements with respect to privacy and utility objectives. To achieve this, the exemplary embodiments employ an adversarial learning formulation in which a sensor layer with learnable parameters is trained to simultaneously or concurrently promote the success of UTILITYNET, a downstream neural network aims to solve a target vision task, e.g., depth estimation, and inhibit the success of ATTACKNET, a downstream neural network that seeks to infer private information from sensor images, e.g., face identification.

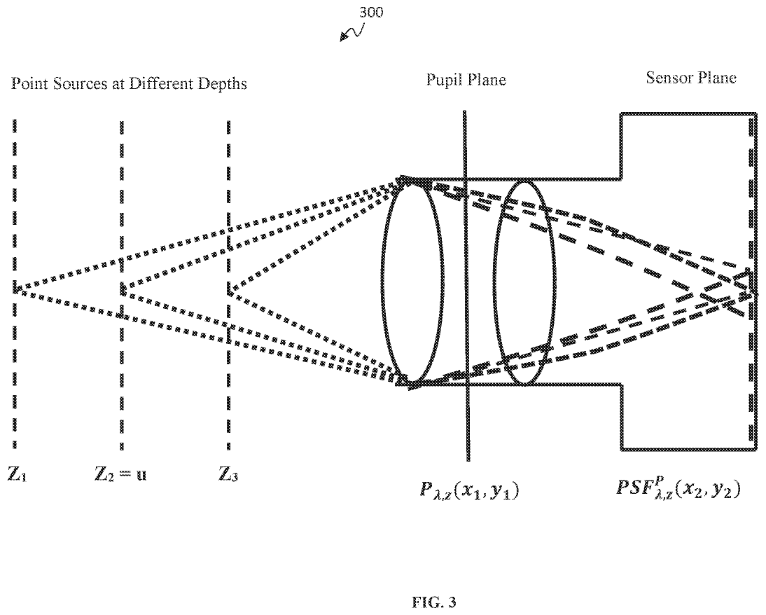

As shown in FIG. 3, the sensor layer 300 includes a 4f imaging system with a learnable phase mask positioned in the aperture plane. Since the sensor layer 300 includes diffractive and wavelength dependent optical elements, the exemplary embodiments model the sensor layer 300 using computational Fourier optics.

The exemplary embodiments characterize the sensor layer 300 via a wavelength and depth dependent pupil function:

P_{λ,z}(x₁,y₁)=A(x₁,y₁)e^{-j(ϕ}^{_{λ}}^{^{mask}}^{(x}^{₁}^{,y}^{₁}^{)+ϕ}^{_{λ,z}}^{^{lens}}^{(x}₁,y₁))

where A∈ [symbol] ^{W}^{₁}^{×H}^{₁} denotes the amplitude modulation due to the aperture and ϕₘₐₛₖ∈ [symbol] ^{W}^{₁}^{×H}^{₁} and ϕₗₑₙₛ∈ [symbol] ^{W}^{₁}^{×H}^{₁} the phase modulation due to the phase mask and lenses, respectively.

The above amplitude modulation is given by:

$$A ( {x}_{1} , {y}_{1} ) = \{ \begin{matrix}1 & if \sqrt{{x}_{1}^{2} + {y}_{1}^{2}} \leq \frac{d}{2} \\ 0 & else\end{matrix}$$

where d denotes the diameter of the aperture.

The phase modulation due to the phase mask and is given by:

ϕ_{λ}^{mask}(x₁,y₁)=k_{λ}Δnh(x₁,y₁)

where

$${k}_{λ} = \frac{2 π}{λ}$$

denotes the wave number, Δₙ the difference between the refractive indices of air and the phase mask material, and h∈ [symbol] ^{W}^{₁}^{×H}^{₁} the height of the phase mask pixels. The sensor layer adversarially learns the height h, which is then fabricated for the prototype design.

The phase modulation due to the two lenses of the 4f system can be modeled as a single lens with effective focal length f′.

The analytical expression for defocus phase modulation due to a single lens is given by:

$${ϕ}_{λ , z}^{lens} ( {x}_{1} , {y}_{1} ) = {k}_{λ} \frac{{x}_{1}^{2} + {y}_{1}^{2}}{2} ( \frac{1}{z} - \frac{1}{μ} )$$

where z denotes the scene point distance and u the focal plane distance. The corresponding point-spread-function (PSF) for the pupil function P_{λ,z} is given by:

$${PSF}_{λ , 2}^{P} ( {x}_{2} , {y}_{2} ) = {\vert ℱ \{ {P}_{λ , z} ( \frac{{x}_{2}}{λ {f}^{′}} , \frac{{y}_{2}}{λ {f}^{′}} ) \} \vert}^{2}$$

Finally, let I_{λ}∈ [symbol] ^{W}^{₂}^{×H}^{₂} and M∈ [symbol] ^{W}^{₂}^{×H}^{₂} denote an all-in-focus image and its corresponding depth map respectively, then the image formed by the sensor layer is:

$${I}_{λ}^{′} ( {x}_{2} , {y}_{2} ) = {\sum }_{i = 1}^{N} [ {I}_{λ} ( {x}_{2} , {y}_{2} ) \cdot {1}_{M ( {x}_{2} , {y}_{2} ) = {z}_{i}} ] {PSF}_{λ , z}^{P} ( {x}_{2} , {y}_{2} )$$

where z₁, . . . , z_{N} denotes a set of N discrete depths and 1_{M(x}_{₂}_{,y}_{₂}_{)=z}_{ᵢ}∈ [symbol] ^{W}^{_{2×}}^{H}^{₂} an indicator function that is true when M(x₂,y₂)=z₁.

Regarding accounting for non-idealities, diffractive optical elements (DOE), whether fabricated or generated using a spatial light modulator (SLM), suffer from a zero-order spot, due to light travelling through the optical elements undiffracted. This may be due to a variety of factors such as light passing through dead regions of an SLM, defects in surface topography of a printed DOE, the inhomogeneity and dispersive optical property of phase element materials, illumination beyond the extent of the DOE, and more.

In previous deep optics works, the zero-order issue was ignored, as the superposition of the diffracted and undiffracted images did not degrade the performance of the downstream neural networks. However, the same cannot be said when considering a privacy objective, as the undiffracted images may reveal private information, if not accounted for.

For an imaging sensor with a phase mask in the Fourier plane, the zero-order spot manifests in a straightforward way. Namely, the resulting image from the sensor includes a linear combination of two images, the diffracted image and the undiffracted image. The PSF involved in generating the diffracted image is described in PSF for the pupil function. The PSF involved in generating the undiffracted image is equivalent to the PSF for the pupil function minus the phase modulation due to the phase mask.

Accordingly, the pupil function for the undiffracted image is given by:

Q_{λ,z}(x₁,y₁)=A(x₁,y₁)e^{-jϕ}^{_{λ,z}}^{^{lense}}^{(x}^{₁}^{,y}^{₁}⁾

and the corresponding PSF for the pupil function Q_{λ,z} is given by:

$${PSF}_{λ , z}^{Q} ( {x}_{2} , {y}_{2} ) = {\vert ℱ \{ {Q}_{λ , z} ( \frac{{x}_{2}}{λ {f}^{′}} , \frac{{y}_{2}}{λ {f}^{′}} ) \} \vert}^{2}$$

Thus, the non-ideal PSF for the entire imaging system is given by:

PSF_{λ,z}^{P,Q}(x₂,y₂)=PSF_{λ,z}^{P}(x₂,y₂)+νPSF_{λ,z}^{Q}(x₂,y₂)

where ν>0 denotes a scalar value that varies (usually between 0.08 to 0.2) depending on the phase mask pattern and technology used to generate the phase mask.

Finally, image formation is governed by the same process described in (x₂, y₂) except that PSF_{λ,z}^{P} is replaced by PSF_{λ,z}^{P,Q} to account for the zero-order PSF.

Regarding optimization, the sensor layer and S:∈ [symbol] ^{W}^{₂}^{×H}^{₂}^{×3}→ [symbol] ^{W}^{₂}^{×H}^{₂}^{×3} maps an all-in-focus image I∈ [symbol] ^{W}^{₂}^{×H}^{₂}^{×3} to a sensor image I′=S(I)∈ [symbol] ^{W}^{₂}^{×H}^{₂}^{×3}. The goal is to optimize the parameters of the sensor layer, namely the heights of the phase mask h∈ [symbol] ^{W}^{₁}^{×H}^{₁} such that the sensor images I′ cannot be used for estimation of sensitive attributes g(I)∈ [symbol] , but can be used for estimation of the target attributes t(I)∈ [symbol] . To achieve this, the exemplary embodiments employ an adversarial training formulation in which the sensor layer is trained to simultaneously promote the success of UTILITYNET U: [symbol] ^{W}^{₂}^{×H}^{₂}→ [symbol] while inhibiting the success of ATTACKNET A: [symbol] ^{W}^{₂}^{×H}^{₂}^{×3}→ [symbol] .

Let L_{U}(t(i),U(i)) and L_{A} (t(i),A(i)) denote the loss functions for UTILITYNET and ATTACKNET for target and attack tasks, respectively.

Then, the loss function for the sensor layer is given by:

L_{S}(t(I),(U(I))=min L_{U}(t(I),U(I))−αL_{A}(t(I),A(I))

where α>0 is a scalar weight, which the exemplary embodiments refer to as the privacy weight that controls the privacy-utility trade-off.

Regarding vision layers, downstream of the sensor layer, the exemplary embodiments have two neural networks, UTILITYNET and ATTACKNET. The architectures and corresponding objective functions of these networks can be designed to suit the user defined utility and attack tasks, respectively. The exemplary embodiments define the utility task as monocular depth estimation and the attack task as face identification. Thus, the expected effect of the learned phase mask is to obfuscate identifiable facial information, while boosting the depth estimation accuracy. While the framework may easily generalize to other utility and attack tasks, the next section describes UTILITYNET and ATTACKNET in this context.

Regarding UTILITYNET, the exemplary embodiments adopt the ResNet-based multi-scale network as the architecture for UTILITYNET, as it has been shown to be effective for the task of monocular depth estimation, and the exemplary embodiments initialize the model with pre-trained weights. For UTILITYNET's objective function, the exemplary embodiments adopt a weighted sum of losses on the depth, gradient and perceptual quality:

L_{U}(y,ŷ)=ξL_{depth}(y,ŷ)+L_{grad}(y,ŷ)+L_{SSIM}(y,ŷ)

where y and ŷ denote the ground-truth and estimated depth maps respectively, and ξ denotes a weighting parameter, which the exemplary embodiments set to 0:1.

Regarding ATTACKNET, the exemplary embodiments use ResNet50 as the network architecture for ATTACKNET, as it has been shown to be effective for face identification. For ATTACKNET's objective function, the exemplary embodiments adopt a softmax activation followed by a cross-entropy loss for n-way classification. Finally, for evaluating face recognition performance, the exemplary embodiments learn one-vs-all SVM classifiers for each test subject, using a held-out subset of the evaluation set.

In summary, cameras are becoming an omnipresent part of public and private spaces spurred on by the remarkable functionalities they can enable. With this remarkable success, serious questions and concerns about privacy have emerged. Existing approaches rely on a combination of data encryption to provide security, and post-capture privacy-enhancing encodings to provide privacy and are thus vulnerable to sniffing attacks and other in-network attacks.

The exemplary embodiments achieve privacy-enhancing encodings completely in the optical domain before an image is acquired, thus ensuring that private data never reaches the digital domain where it's susceptible to digital vulnerabilities. The exemplary embodiments explore the limited design space of a single-phase mask placed within the aperture plane of a conventional camera and show that even such simple design choices provide significant control over privacy-utility tradeoffs. The exemplary embodiments thus demonstrate an end-end adversarial learning pipeline where the optical encoding can be optimized given a particular choice of utility and privacy metrics.

In conclusion, over a billion cameras are manufactured each year, with a large number of them used for automated inference in applications such as robotics, autonomous navigation, mobile photography and smart homes. However, severe concerns on privacy have arisen that prevent the use of cameras in a range of environments. The key question addressed is: Can a novel imaging system be created that provides the machine intelligence capabilities of a conventional camera without violating privacy rights and expectations? The solution is to add a phase mask in the aperture of a conventional camera, to create a depth-dependent image blur that is a function of the phase mask. By end-to-end learning of the phase mask pattern, the exemplary embodiments perform optical pre-filtering that retains all the information needed for downstream computer vision tasks, while suppressing features that might be considered private. This ensures that data sniffing or leakage are prevented, since private information is never acquired by the camera. The exemplary embodiments further fabricate the optimized optics and use these optics to construct a prototype sensor that enables state-of-the-art monocular depth estimation while inhibiting face identification.

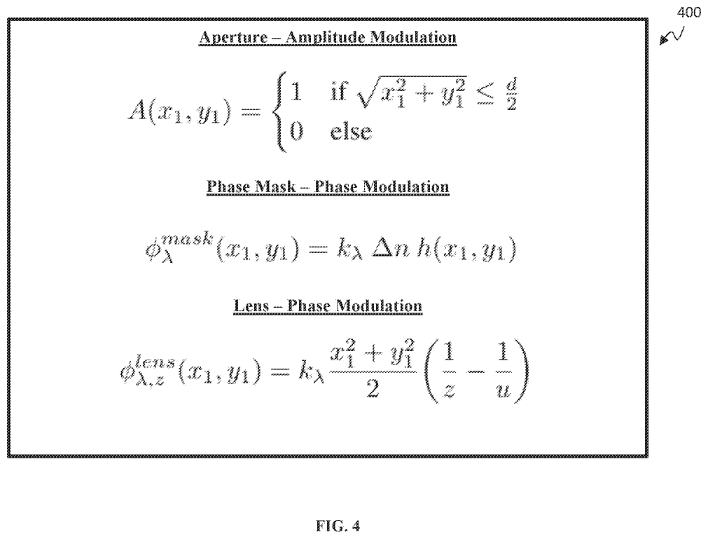

FIG. 4 is a block/flow diagram of exemplary equations 400 for aperture amplitude modulation, phase mask (phase modulation), and lens (phase modulation), in accordance with embodiments of the present invention.

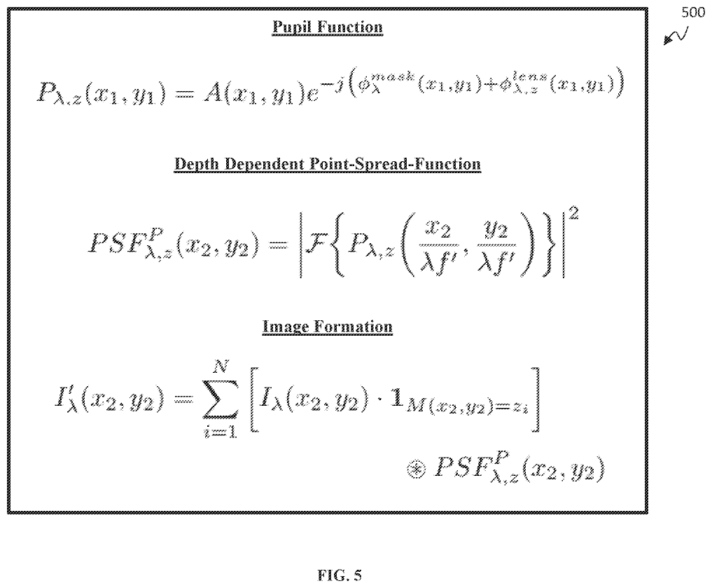

FIG. 5 is a block/flow diagram of exemplary equations 500 for pupil function, depth dependent point-spread-function, and image formation, in accordance with embodiments of the present invention.

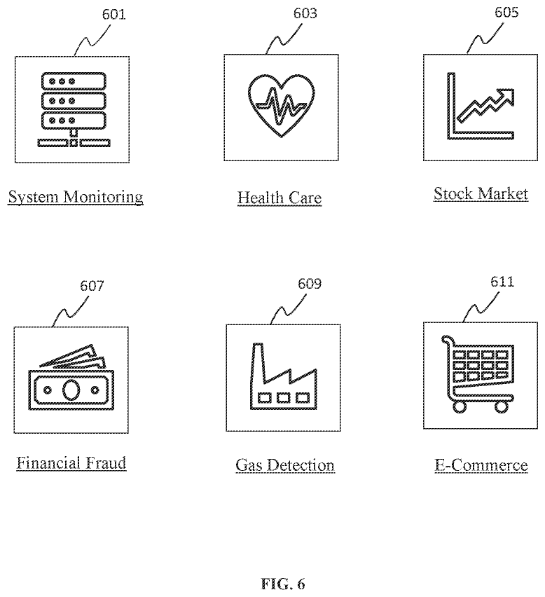

FIG. 6 is a block/flow diagram of an exemplary practical application for the privacy-processing system, in accordance with embodiments of the present invention.

Practical applications for learning trends in multivariate time series data can include, but are not limited to, system monitoring 601, healthcare 603, stock market data 605, financial fraud 607, gas detection 609, and e-commerce 611. Privacy-aware sensing can be applied in further practical applications, such as nursing homes, schools, airports, hospitals, retail, and augmented reality. In nursing homes, privacy processing can be applied to slip-and-fall, elder abuse, mistreatment, home invasions, robbery, sundowning, and video-based memory recovery for patient suffering from memory loss. In schools, privacy processing can be applied to restrooms, locker rooms, child abuse cases, mistreatment cases, bullying, fighting, and illicit activity. In airports, privacy processing can be applied to restrooms, narcotics busts, weapons, social distancing, etc. In hospitals, privacy processing can be applied to compliance with hygiene protocols, slip-and-fall, patient abuse or mistreatment, patient wandering and social distancing. In retail, privacy processing can be applied to monitoring product engagement, theft in fitting rooms or bathrooms, and social distancing. In augmented reality and artificial intelligence (AI), privacy processing can be applied to localization, depth estimation, and optical flow estimation. One skilled in the art can contemplate further practical applications. As a result, privacy-aware sensing opens huge markets for deploying vision in privacy sensitive environments.

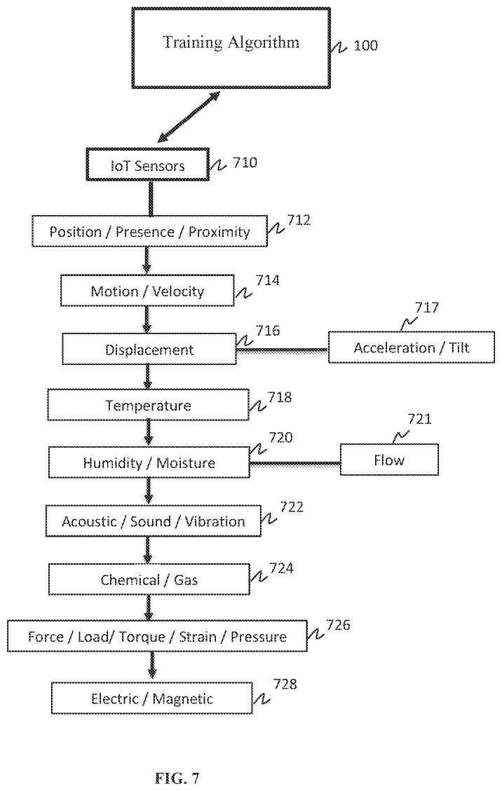

The time-series data in such practical applications can be collected by sensors 710 (FIG. 7).

FIG. 7 is a block/flow diagram of exemplary Internet-of-Things (IoT) sensors used to collect data/information for the privacy-processing system, in accordance with embodiments of the present invention.

IoT loses its distinction without sensors. IoT sensors act as defining instruments which transform IoT from a standard passive network of devices into an active system capable of real-world integration.

The IoT sensors 710 can communicate with the training algorithm 100 to process information/data, continuously and in in real-time. Exemplary IoT sensors 710 can include, but are not limited to, position/presence/proximity sensors 712, motion/velocity sensors 714, displacement sensors 716, such as acceleration/tilt sensors 717, temperature sensors 718, humidity/moisture sensors 720, as well as flow sensors 721, acoustic/sound/vibration sensors 722, chemical/gas sensors 724, force/load/torque/strain/pressure sensors 726, and/or electric/magnetic sensors 728. One skilled in the art can contemplate using any combination of such sensors to collect data/information for input into the training algorithm 100 for further processing. One skilled in the art can contemplate using other types of IoT sensors, such as, but not limited to, magnetometers, gyroscopes, image sensors, light sensors, radio frequency identification (RFID) sensors, and/or micro flow sensors. IoT sensors can also include energy modules, power management modules, RF modules, and sensing modules. RF modules manage communications through their signal processing, WiFi, ZigBee®, Bluetooth®, radio transceiver, duplexer, etc.

Moreover data collection software can be used to manage sensing, measurements, light data filtering, light data security, and aggregation of data. Data collection software uses certain protocols to aid IoT sensors in connecting with real-time, machine-to-machine networks. Then the data collection software collects data from multiple devices and distributes it in accordance with settings. Data collection software also works in reverse by distributing data over devices. The system can eventually transmit all collected data to, e.g., a central server.

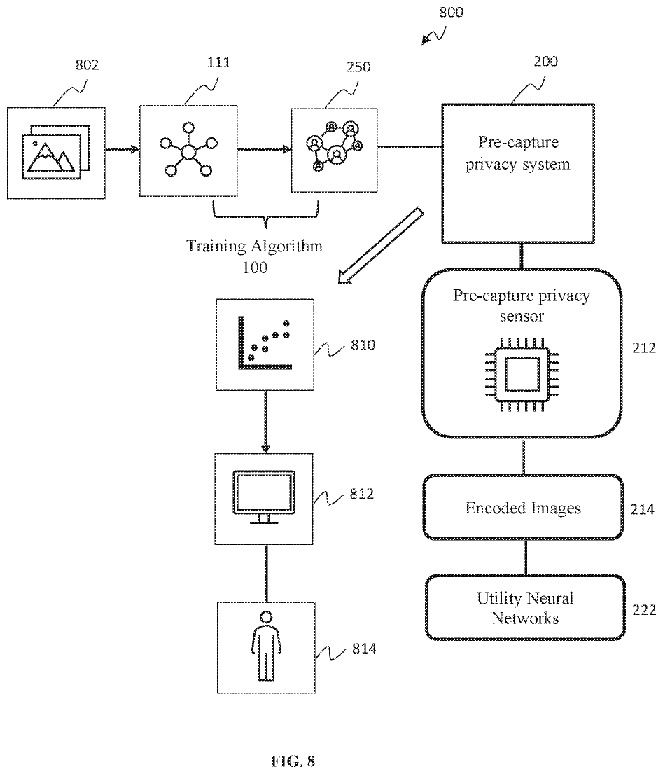

FIG. 8 is a block/flow diagram 800 of a practical application of the privacy-processing system, in accordance with embodiments of the present invention.

In one practical example, images 802 are obtained from cameras. The images are processed by a training algorithm 100 including a differentiable sensing model 111 and an adversarial learning framework 250. The exemplary methods execute the privacy-processing system by a pre-capture privacy system 200 that is implemented via a pre-capture privacy sensor 212 with encoded images 214 and utility neural networks 222. The results 810 (e.g., design options) can be provided or displayed on a user interface 812 handled by a user 814.

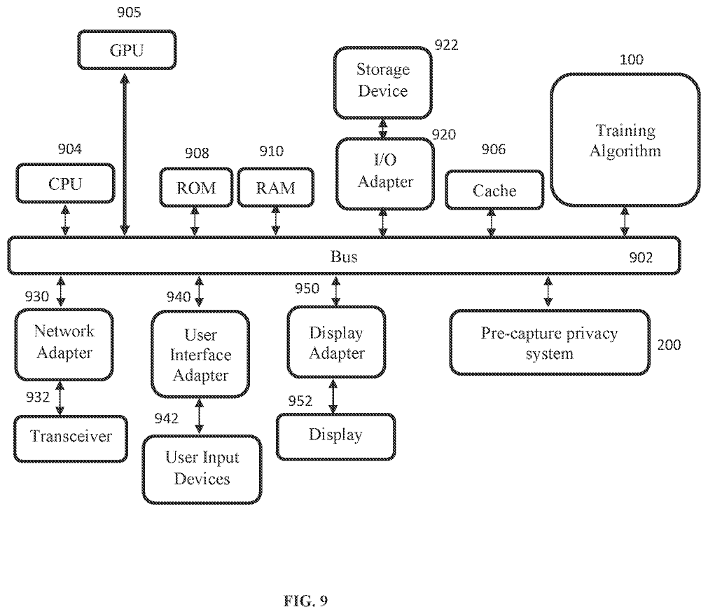

FIG. 9 is an exemplary processing system for the privacy-processing system, in accordance with embodiments of the present invention.

The processing system includes at least one processor (CPU) 904 operatively coupled to other components via a system bus 902. A GPU 905, a cache 906, a Read Only Memory (ROM) 908, a Random Access Memory (RAM) 910, an input/output (I/O) adapter 920, a network adapter 930, a user interface adapter 940, and a display adapter 950, are operatively coupled to the system bus 902. Additionally, a training algorithm 100 can be employed with the pre-capture privacy system 200 to enable privacy-processing, as described herein with respect to the exemplary embodiments.

A storage device 922 is operatively coupled to system bus 902 by the I/O adapter 920. The storage device 922 can be any of a disk storage device (e.g., a magnetic or optical disk storage device), a solid-state magnetic device, and so forth.

A transceiver 932 is operatively coupled to system bus 902 by network adapter 930.

User input devices 942 are operatively coupled to system bus 902 by user interface adapter 940. The user input devices 942 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 942 can be the same type of user input device or different types of user input devices. The user input devices 942 are used to input and output information to and from the processing system.

A display device 952 is operatively coupled to system bus 902 by display adapter 950.

Of course, the processing system may also include other elements (not shown), as readily contemplated by one of skill in the art, as well as omit certain elements. For example, various other input devices and/or output devices can be included in the system, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system are readily contemplated by one of ordinary skill in the art given the teachings of the present invention provided herein.

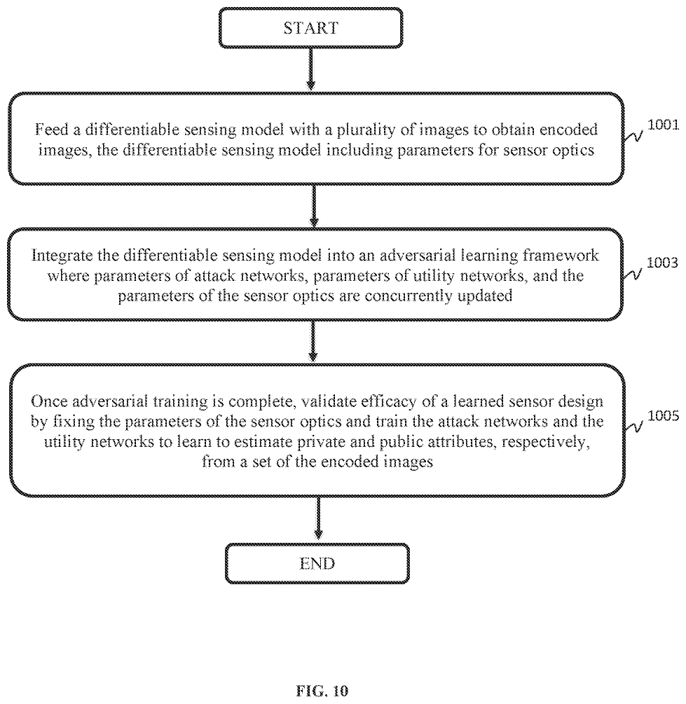

FIG. 10 is a block/flow diagram of an exemplary method for executing the MILD, in accordance with embodiments of the present invention.

At block 1001, feed a differentiable sensing model with a plurality of images to obtain encoded images, the differentiable sensing model including parameters for sensor optics.

At block 1003, integrate the differentiable sensing model into an adversarial learning framework where parameters of attack networks, parameters of utility networks, and the parameters of the sensor optics are concurrently updated.

At block 1005, once adversarial training is complete, validate efficacy of a learned sensor design by fixing the parameters of the sensor optics and train the attack networks and the utility networks to learn to estimate private and public attributes, respectively, from a set of the encoded images.

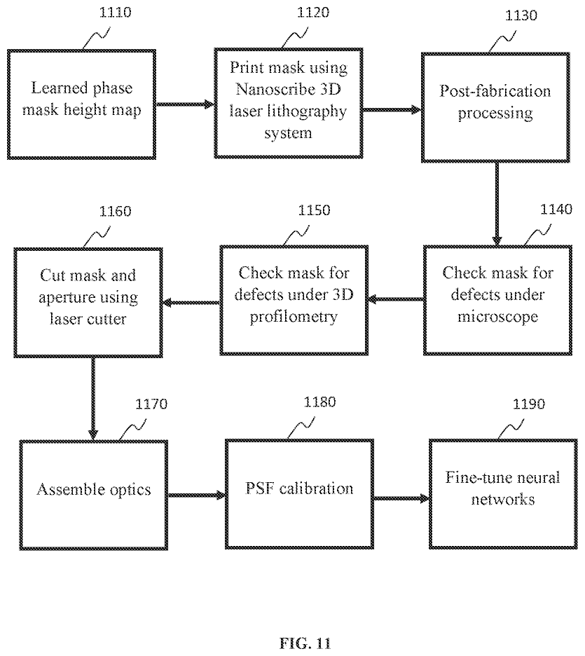

FIG. 11 is a block/flow diagram of an exemplary sensor fabrication pipeline, in accordance with embodiments of the present invention.

At block 1110, a learned phase mask height map is provided.

At block 1120, a print mask is used by employing, e.g., a Nanoscribe 3D laser lithography system.

At block 1130, post-fabrication processing takes place.

At block 1140, the mask is checked for defects under a microscope.

At block 1150, the mask is checked for defects under 3D profilometry.

At block 1160, the mask and aperture are cut by using a laser cutter.

At block 1170, the optics are assembled.

At block 1180, point-spread-function (PSF) calibration takes place.

At block 1190, the neural networks are fine-tuned.

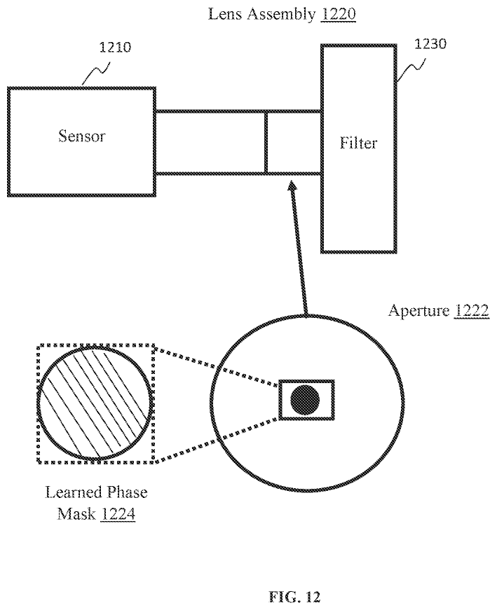

FIG. 12 is a prototype sensor with optimized phase mask, in accordance with embodiments of the present invention.

The sensor 1210 includes a lens assembly 1220 and a filter 1230. The lens assembly 1220 includes an aperture 1222. The aperture 1222 includes a learned phase mask 1224.

As used herein, the terms “data,” “content,” “information” and similar terms can be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, the data can be received directly from the another computing device or can be received indirectly via one or more intermediary computing devices, such as, for example, one or more servers, relays, routers, network access points, base stations, and/or the like. Similarly, where a computing device is described herein to send data to another computing device, the data can be sent directly to the another computing device or can be sent indirectly via one or more intermediary computing devices, such as, for example, one or more servers, relays, routers, network access points, base stations, and/or the like.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “calculator,” “device,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can include, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or modules.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks or modules.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks or modules.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for acquiring privacy-enhancing encodings in an optical domain before image capture, the method comprising:
feeding a differentiable sensing model with a plurality of images to obtain encoded images, the differentiable sensing model including parameters for sensor optics;
integrating the differentiable sensing model into an adversarial learning framework where parameters of attack networks, parameters of utility networks, and the parameters of the sensor optics are concurrently updated; and
once adversarial training is complete, validating efficacy of a learned sensor design by fixing the parameters of the sensor optics and training the attack networks and the utility networks to learn to estimate private and public attributes, respectively, from a set of the encoded images.

2. The method of claim 1, wherein the parameters for the sensor optics of the differentiable sensing model are optimized via an adversarial loss function.

3. The method of claim 2, wherein the parameters for the sensor optics of the differentiable sensing model are optimized via the adversarial loss function to concurrently prevent the attack networks from succeeding at learning to estimate the private attributes from the encoded images and to enable the utility networks to succeed at estimating the public attributes from the encoded images.

4. The method of claim 1, wherein the utility networks include a training component for optimizing the parameters of the utility networks to map the encoded images to public attribute labels.

5. The method of claim 1, wherein the attack networks include a training component for optimizing the parameters of the attack networks to map the encoded images to private attribute labels in order to simulate an attack by an adversary seeking to recover values of the private attributes.

6. The method of claim 1, wherein the differentiable sensing model communicates with a pre-capture privacy system having a pre-capture privacy sensor and a set of utility neural networks.

7. The method of claim 6, wherein a pre-capture privacy camera optically filters an incident light field to directly capture the encoded images.

8. The method of claim 7, wherein the encoded images inhibit estimation of the private attributes and do not inhibit estimation of the public attributes.

9. The method of claim 8, wherein the set of utility neural networks are used to estimate the public attributes from the encoded images.

10. A non-transitory computer-readable storage medium comprising a computer-readable program for acquiring privacy-enhancing encodings in an optical domain before image capture, wherein the computer-readable program when executed on a computer causes the computer to perform the steps of:
feeding a differentiable sensing model with a plurality of images to obtain encoded images, the differentiable sensing model including parameters for sensor optics;
integrating the differentiable sensing model into an adversarial learning framework where parameters of attack networks, parameters of utility networks, and the parameters of the sensor optics are concurrently updated; and
once adversarial training is complete, validating efficacy of a learned sensor design by fixing the parameters of the sensor optics and training the attack networks and the utility networks to learn to estimate private and public attributes, respectively, from a set of the encoded images.

11. The non-transitory computer-readable storage medium of claim 10, wherein the parameters for the sensor optics of the differentiable sensing model are optimized via an adversarial loss function.

12. The non-transitory computer-readable storage medium of claim 11, wherein the parameters for the sensor optics of the differentiable sensing model are optimized via the adversarial loss function to concurrently prevent the attack networks from succeeding at learning to estimate the private attributes from the encoded images and to enable the utility networks to succeed at estimating the public attributes from the encoded images.

13. The non-transitory computer-readable storage medium of claim 10, wherein the utility networks include a training component for optimizing the parameters of the utility networks to map the encoded images to public attribute labels.

14. The non-transitory computer-readable storage medium of claim 10, wherein the attack networks include a training component for optimizing the parameters of the attack networks to map the encoded images to private attribute labels in order to simulate an attack by an adversary seeking to recover values of the private attributes.

15. The non-transitory computer-readable storage medium of claim 10, wherein the differentiable sensing model communicates with a pre-capture privacy system having a pre-capture privacy sensor and a set of utility neural networks.

16. The non-transitory computer-readable storage medium of claim 15, wherein a pre-capture privacy camera optically filters an incident light field to directly capture the encoded images.

17. The non-transitory computer-readable storage medium of claim 16, wherein the encoded images inhibit estimation of the private attributes and do not inhibit estimation of the public attributes.

18. The non-transitory computer-readable storage medium of claim 17, wherein the set of utility neural networks are used to estimate the public attributes from the encoded images.

19. A system for acquiring privacy-enhancing encodings in an optical domain before image capture, the system comprising:
a differentiable sensing model fed with a plurality of images to obtain encoded images, the differentiable sensing model including parameters for sensor optics; and
an adversarial learning framework integrated with the differentiable sensing model where parameters of attack networks, parameters of utility networks, and the parameters of the sensor optics are concurrently updated;
wherein, once adversarial training is complete, validating efficacy of a learned sensor design by fixing the parameters of the sensor optics and training the attack networks and the utility networks to learn to estimate private and public attributes, respectively, from a set of the encoded images.

20. The system of claim 19, wherein the parameters for the sensor optics of the differentiable sensing model are optimized via an adversarial loss function to concurrently prevent the attack networks from succeeding at learning to estimate the private attributes from the encoded images and to enable the utility networks to succeed at estimating the public attributes from the encoded images.
